(19) United States
(12) Patent Application Publication
(10) Pub. No.: US 2007/0196260 A1
(43) Pub. Date: Aug. 23, 2007

(54) Process for producing transition metal ion crosslinked electrode material

(75) Inventors: Shinichi Kikkawa, Hokkaido (JP); Hiroki Tamura, Hokkaido (JP); Takashi Takeda, Hokkaido (JP)

Correspondence Address: EDWARDS ANGELL PALMER & DODGE LLP, P.O. BOX 55874, BOSTON, MA, 02205, US

(73) Assignee: National University Corporation Hokkaido University, Hokkaido (JP)

(21) Appl. No.: 11/632,388

(22) PCT Filed: Jul. 8, 2005
(86) PCT No.: PCT/JP05/12673

§ 371 Date: Jan. 12, 2007

(30) Foreign Application Priority Data
Jul. 13, 2004 (JP) 2004-206137

(51) Int. Cl. C01B 21/06

(52) U.S. Cl. 423/409

(57) ABSTRACT

The present invention relate to a method for producing a transition metal ion bridging positive electrode material, wherein a mono-valent transition metal complex ion is intercalated into an interlayer space of layered transition metal oxide containing therein an alkali metal complex ion. The method of the present invention provides safe and simple operation without using acid and organic compound required in the prior art. The method of the present invention also provides an advantageous method in terms of cost performance by employing the procedure for producing a positive electrode via the layered transition metal oxide containing alkali metal complex ion within the layers, preferably via the layered manganese oxide buserite.

### FIELD OF THE INVENTION

The present invention relates to a method for producing positive electrode material for lithium ion batteries, wherein a mono-valent transition metal complex ion is intercalated into the interlayer space of the layered transition metal oxide containing an alkali metal complex ion, particularly wherein a transition metal is intercalated into the interlayer space of layered manganese oxide buserite.

### BACKGROUND ART

Lithium rechargeable (secondary) batteries are promising next-generation batteries among dischargeable/chargeable secondary batteries, which can be miniaturized and increased in capacitance as well as voltage as compared to nickel-hydrogen batteries. However, the propagation thereof is limited due to the high cost and shortage in supply of cobalt metal in lithium cobalt oxide used for the positive electrode.

Use of transition metals such as vanadium, chromium, manganese, iron, cobalt, nickel and particularly manganese which is abundant in natural resources, has come into consideration as alternative materials of lithium cobalt oxide for positive electrode. However, the use of manganese metal for rechargeable batteries resulted in insufficient batteries' characteristics due to the likelihood of replacement of lithium ion by metal ion within the crystal structure during synthesis and charging/discharging procedures. Particularly, the following disadvantage of the characteristics has been pointed out: - - - poor in charge-discharge reversibility (charge-discharge cycle behavior, which is one of the important characteristics for secondary batteries) i.e. the capacitance of positive electrode may gradually degrade due to the repetition of charge-discharge cycles - - - . It is confirmed that the above disadvantage is resulted from the collapse of the crystal structure of the layered manganese oxide, particularly from the exfoliation of the layers thereof

A manganese oxide compound comprising the complex of layered manganese and Li₂MnO₃ as a positive electrode material with improved reversibility has been reported (see patent literature 1). Lithium rechargeable (secondary) batteries with remarkable charge-discharge cycle behavior can be obtained from the positive electrode material, wherein the crystal structure of the layered manganese oxide is stabilized by formation of complexes with Li₂MnO₃. However, there is a problem of degradation in discharge capacity as well as cycle behavior after a long-term storage charged with the voltage of more than a certain level.

Another report indicates a method of producing nano-complex of a layered manganese oxide compound characterized by: (1) preparing nanosheets by swelling or exfoliating a layered manganese oxide in water; (2) re-assembling them by mixing thereinto nanoparticle-forming components; and (3) thereby intercalating the nanoparticles into the interlayer space of layered manganese oxide (see patent literature 2).

However, since the method requires intercalation of tetraalkyl-ammonium ion such as tetramethyl-ammonium ion and tetraethyl-ammonium ion into the layered manganese oxide, the use of such ammonium materials as well as the washing procedure thereof is also required.

A further report indicates that a method of producing a layered manganese oxide intercalated with transition metal, via the layered manganese oxide intercalated with n-propylamine (propyl-amine birnessite). (see non-patent literature 1).

However, this method also requires the use of high irritant chemicals such as hydrochloric acid and n-propyl amine. The method further requires the multiple steps for intercalation of the transition metal ion: firstly H birnessite, wherein hydrogen is intercalated into the interlayer space of the layered manganese oxide; followed by propyl-amine birnessite, wherein propyl-amine is intercalated into the interlayer space of the layered manganese oxide; and finally the transition metal is intercalated into the interlayer space of the layered manganese oxide. In view of industrial applicability, this method is too complicated to employ for producing a positive electrode material.

Cited Documents

Patent literature 1: JP, 63-114064, A
Patent literature 2: JP, 2003-201121, A
Non-patent literature 1: Kyosuke Nakamura, et al. “Synthesis of Layered Manganese oxide, Na_{X}MnO₂ and Its Interlayer Modification” P.34-36, Abstract of the 13th Symposium on Reactivity of Solids, Ken Hirota, Nov. 14, 2002.

### SUMMARY OF THE INVENTION

The present inventors conducted the study to readily provide a positive electrode material with enhanced charge-discharge cycle behavior, comprising a layered transition metal oxide intercalated with transition metal, and consequently found that the positive electrode material comprising a layered transition metal oxide intercalated with transition metal which can easily be prepared via a layered transition metal oxide containing alkali metal complex ion within the layers, particularly via a layered manganese buserite, and thus have completed the invention as follows:
1) A method for producing a transition metal bridging positive electrode material, wherein a mono-valent transition metal complex ion is intercalated into the interlayer space of layered transition metal oxides containing an alkali metal complex ion.
2) A method according to 1), wherein the layered transition metal oxide containing an alkali metal complex ion within the layers is selected from the group of the layered oxide of the transition metal consisting of vanadium, chromium, manganese, iron, cobalt and nickel.
3) A method according to 2), wherein the layered transition metal oxide containing an alkali metal complex ion within the layers is a layered manganese oxide buserite.
4) A producing method according to 1), wherein the mono-valent transition metal complex ion is selected from the group consisting of transition metal complex ion consisting of titanium, vanadium, chromium, manganese, molybdenum, tungsten and rhenium.
5) A producing method according to 4), wherein the mono-valent transition metal complex ion is a vanadium complex ion.
6) A producing method according to 1), wherein the mono-valent vanadium complex ion is intercalated into the interlayer space of layered manganese oxide buserite in the aqueous media with pH 5 to 7.

### BRIEF DESCRIPTION OF THE DRAWINGS

FIG. 1 shows the charge-discharge curve of lithium secondary batteries comprising a V birnessite positive electrode (bold line shows the initial cycle).

FIG. 2 shows the plot of discharge capacity and the charge-discharge cycles of lithium secondary batteries comprising a V birnessite positive electrode.

### BEST MODE FOR CARRYING OUT THE INVENTION

This invention relates to a method for forming the bridges of transition metal ions in the vacancies within the crystal structure of transition metal compound by exchanging the cations comprised therein, particularly the cations comprised in vacancies within the layers of a layered transition metal compound, for mono-valent transition metal complex ion (M^{ml+}Lₙ¹⁻; wherein M is transition metal, L is ligand, m and 1 are ≧1). The mono-valent complex ion is preferably a hydoroxomanganate complex ion [Mn⁺(OH)ₙ₋₁ ]⁺(n≧2), and it is construed that the complex ion is intercalated within the crystal structure of transition metal compound and promotes the change of the metal ion valencies, whereby exerts pillaring effects.

In other word, the positive electrode material provided herein has the structure wherein transition metal is intercalated into the interlayer space of layered transition metal oxide containing alkali metal complex ion, e.g. transition metal is intercalated within a layered manganese oxide. Therefore, it is supposed that the positive electrode with excellent charge-discharge cycle behavior can be obtained through the following procedures: The intercalated transition metal is oxidized naturally by a layered transition metal oxide, e.g. the layered manganese oxide and becomes the multi-valent ion; exerts the pillaring effects (connecting layers of manganese oxide); whereby reduces expansion and contraction of manganese oxide layers during the charge—discharge events.

The present invention involves ion exchange reactions between cations present within the layered transition metal oxide and the transition metal by adding transition metal, particularly mono-valent transition metal complex ion, preferably vanadium ion to the layered transition metal oxide containing alkali metal complex ion, typically to the layered manganese oxide buserite.

The present invention relates to a method for producing the positive electrode material via a layered transition metal oxide containing alkali metal complex ion within the layers, particularly via a layered manganese oxide buserite. The layered manganese oxide buserite is a layered manganese oxide filled with more water and cation (typically is a sodium ion) in its layers compared to birnessite. The layered manganese oxide buserite can easily be prepared by adding, for example, solid or powdered manganese nitrate to hydrogen peroxide alkali solution, followed by stirring the mixture vigorously. The obtained layered manganese oxide buserite is dried to give the birnessite.

The equilibrium coefficient for the reaction to form mono-valent transition metal complex ion used for the present invention has already been determined, and is defined according to pH and the concentration of transition metal ion. Thus, the present invention can afford the formation of the desired mono-valent transition metal complex ion by suitably setting pH depending on the transition metal species and the concentration of the ions.

Though not restricted by the following theory, it is supposed that the exchange reaction can readily be promoted between the transition metal (M) (present as cation M(OH⁻)ₙ⁺associated with hydroxide ion (OH⁻) under the above described pH value ) and the cation present in the interlayer of buserite.

For example, the reaction between the buserite and the transition metal, particularly mono-valent vanadium complex ion, is conducted with pH 4-8, preferably with pH 5-7 in the aqueous media.

The method of the present invention requires neither the use of the compound such as tetra-alkyl ammonium ion and n-propyl amine, nor requires the washing procedure of removing the same. Accordingly, the present method can exhibit a better cost performance compared to the conventional method and can readily provide the excellent positive electrode free from inclusion of said compounds.

After termination of the intercalation reaction of the transition metal, the intercalated transition metal within the layers is dried and formed into the positive electrode substance by the conventional method, whereby the positive electrode material with the excellent charge-discharge cycle behavior can be produced.

The layered transition metal oxide used herein preferably is the solid or powdered manganese oxide of which purity and quality can be the same as those of the conventional manganese oxide used for producing the batteries.

The hydrogen peroxide alkali solution used for the preparation of the layered transition metal containing alkali metal complex ion within the layers, preferably a layered manganese oxide buserite, can include the hydrogen peroxide solution of alkali metal salts such as sodium hydroxide solution and potassium hydroxide solution, the hydrogen peroxide solution of alkaline earth metal salts such as calcium hydroxide, or preferably include the hydrogen peroxide solution of sodium hydroxide.

The reaction of the alkali solution with solid or powdered layered transition metal oxide, preferably with manganese nitrate, may be conducted in the mixture of manganese nitrate and alkali with the molar ratio of 0.01-1:1, preferably 0.1-0.5:1, more preferably 0.15-0.35:1. The mixture may be prepared by adding the solid or powdered manganese oxide to hydrogen peroxide alkali solution, or afore-prepared aqueous media of manganese nitrate may be mixed with hydrogen peroxide alkali solution according to the molar ratios as shown above.

To the layered transition metal oxide containing alkali metal complex ion within the layers prepared as described, preferably to the layered manganese oxide buserite, is added the transition metal, particularly the transition metal in the form of mono-valent complex ion, preferably in the form of metal halide compound. The transition metal may be added to a layered transition metal containing alkali metal complex ion within the layers, preferably to the solid or powdered manganese nitrate prior to the conversion into the buserite, with the molar ratio of 0.01-1:1 (transition metal/manganese nitrate), preferably 0.1-1:1, more preferably 0.5-1:1. The transition metal used in this reaction, can include titanium, vanadium, chromium, manganese, molybdenum, tungsten, rhenium and preferably manganese chloride.

The mixing reaction of the layered transition metal oxide containing alkali metal complex ion within the layers, preferably buserite with the transition metal, preferably with mono-valent transition metal complex ion, is conducted by stirring in the aqueous media with pH 4-8, preferably with pH 5-7, at the temperature of between room temperature and about 50° C., for 1-48 hrs, preferably for 5-24 hrs. Finally, the layered transition metal oxide intercalated with transition metal and generated in the aqueous media is centrifuged or filtered, and dried e.g. at the temperature of between room temperature and about 50° C. The obtained product is then formed into the shape by the conventional method to give a positive electrode to use for lithium secondary batteries.

Unless otherwise specified, the material generally used for lithium batteries can be used for the negative electrode active materials and electrolytes constructing lithium secondary batteries. The negative electrode active materials include, for example, lithium metal; alloyed lithium such as lithium-aluminum and lithium-mercury; and hydrocarbon/lithium complex such as polyethylene and graphite. The electrolytes include, for example, the combination of one or more of non-proton organic solvents selected from such as propylene-carbonate (PC), 2-methyl-tetrahydro-furane (2MeTHF), dioxolane and tetrahydro-furane (THF), and one or more of lithium salts such as LiClO₄, LiAlClO₄and LiBF₄; or the inorganic or organic solid electrolyte such as lithium ion conductor selected from

### EXAMPLES

The following Examples are for merely providing illustrations of some of the presently preferred embodiment of this invention but should not be construed as limiting the scope of the invention.

### Example 1

To a mixture of 0.7M of NaOH and 3% of H₂O₂ solution is added 0.3M of MN(NO₃)₂ in the volume ratio 2:1, and the mixture is vigorously stirred for 5 min, and thereby 1 g of buserite is prepared. To this mixture is added 0.2M of Vanadium Chloride solution (35.2 ml) under nitrogen atmosphere, and the mixture is reacted for 24 h with pH 5-7. The mixture is centrifuged to separate precipitates, the obtained precipitates are then dried at 60° C. to give 1.04 g of birnessite (V birnessite) intercalated by vanadium ion.

### Test Example

10 weight parts of V birnessite obtained in example 1, 2 weight parts of Acetylene Black and 1 weight part of PVdF were mixed to form positive electrode films. Rechargeable lithium batteries were produced by use of thus obtained positive electrode, the negative electrode consisting of lithium metal and the electrolyte prepared by adding 1M of LiPF₆ to the mixture of ethylene carbonate and di-ethylene carbonate in the weight ratio of 3:7.

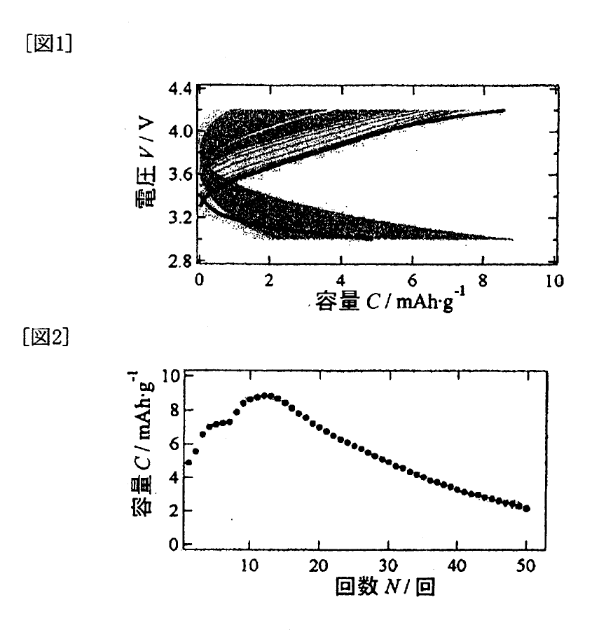

FIG. 1 shows the charge-discharge behavior curve under condition of 0.0565 mA/cm²; 3.0-4.2V

FIG. 2 shows the plot of discharge capacity and charge-discharge cycles.

The figure shows high capacity level of 4 mAh/g-MnO₂ as well as a better and stable cycle behavior.

### INDUSTRIAL APPLICABILITY

The method of present invention provides safe and simple operation without using acid and organic compound required in the prior art. The present method also provides an advantageous method in terms of cost performance by employing the procedure for producing a positive electrode via the layered transition metal oxide containing alkali metal complex ion within the layers preferably via the layered manganese oxide buserite.

1. A method for producing a transition metal ion bridging positive electrode material, wherein a mono-valent transition metal complex ion is intercalated into the interlayer space of layered transition metal oxide containing an alkali metal complex ion.

2. The method according to claim 1, wherein the layered transition metal oxide containing an alkali metal complex ion in the interlayer space thereof is the layered oxide of the transition metal selected from the group consisting of vanadium, chromium, manganese, iron, cobalt and nickel.

3. The method according to claim 2, wherein the layered transition metal oxide containing an alkali metal complex ion in the interlayer space thereof is the layered manganese oxide buserite.

4. A producing method according to claim 1, wherein the mono-valent transition metal complex ion is the transition metal complex ion selected from the group consisting of titanium, vanadium, chromium, manganese, molybdenum, tungsten and rhenium.

5. The producing method according to claim 4, wherein the mono-valent transition metal complex ion is a vanadium complex ion.

6. The producing method according to claim 1, wherein the mono-valent vanadium complex ion is intercalated into the interlayer space of the layered manganese oxide buserite in the aqueous media with pH 5 to 7.
